(19) United States
(12) Patent Application Publication
(10) Pub. No.: US 2006/0158027 A1
(43) Pub. Date: Jul. 20, 2006

(54) Brake booster

(75) Inventor: Jurgen Faller, Kahl (DE)

Correspondence Address: Gerlinde M Nattler;Craig Hallacher, Continental Teves Inc, One Continental Drive, Auburn Hills, MI, 48326, US

(73) Assignee: Continental Teves AG & Co. oHG

(21) Appl. No.: 10/562,325

(22) PCT Filed: Jul. 1, 2004
(86) PCT No.: PCT/EP04/51324

§ 371 Date: Dec. 23, 2005

(30) Foreign Application Priority Data
Jul. 1, 2003 (DE) 103 29 488.0

(51) Int. Cl. B60T 8/44

(52) U.S. Cl. 303/114.3

(57) ABSTRACT

Disclosed is a brake booster having a fixing portion (1) that is aligned eccentrically with respect to the portion of the connecting pin (4) penetrating the housing (2) and the working piston (3).

### BACKGROUND OF THE INVENTION

The present invention relates to a brake booster for a motor vehicle including a housing divided into two chambers by a piston and a push rod connectible to the brake booster dependent upon a force thereon.

DE 198 32 357 A1 discloses a brake booster for a motor vehicle having several connecting pins which extend through the housing of the brake booster in a parallel arrangement relative to a push rod and piston rod. Each of the ends of the connecting pins projecting from both sides of the housing include a fixing portion aligned concentrically to the longitudinal axis of the pins in order to connect the brake booster to a master brake cylinder and to the accommodating bores of a splashboard of the motor vehicle.

The selected design of the brake booster requires the distances of the connecting pins, the housing, and the inside parts of the housing to be adapted individually to the different distances of the accommodating bores in the splashboard and, thus, in each case to the vehicle-specific connecting pattern at the splashboard.

### SUMMARY OF THE INVENTION

In view of the above, an object of the invention involves improving a brake booster of the indicated type with least possible effort in such as fashion that the above-mentioned drawbacks are avoided to a large extent.

According to the invention, this object is achieved for a brake booster having a housing having at least one longitudinally movable working piston that subdivides the housing into at least two chambers, a push rod connectible to a master brake cylinder depending on a force acting upon a piston rod, and a connecting pin having at least one portion that penetrates the housing and the working piston in parallel to the push rod and piston rod. of the indicated type by the characterizing features of patent

### BRIEF DESCRIPTION OF THE DRAWINGS

Further features, advantages, and possible applications of the invention become apparent from following description of several embodiments making reference to the accompanying drawings.

In the drawings:

FIG. 1 is a partial longitudinal cross-sectional view of a brake booster with the essential feature of the invention of a fixing portion that is eccentrically arranged at the connecting pin;

FIG. 2 is an enlarged perspective view of the connecting pin shown in FIG. 1;

FIG. 3 is a partial view of an appropriate design of the brake booster illustrated in FIG. 1, with an opening in the housing configured as an elongated hole for the passage of a fixing portion that is eccentrically arranged at the connecting pin;

FIG. 4 shows an arrangement of the connecting pin known from FIG. 3, shifted by half a rotation in the elongated hole, for the purpose of adapting the distance between the pins to an enlarged distance between the holes in the splashboard of a motor vehicle;

FIG. 5 is an inside view of a housing shell for depicting the arrangement of two diametrical elongated holes in the housing, which are arranged between several guiding surfaces shaped on the inside surface of the housing;

FIG. 6 is a perspective view of a connecting pin having a contour that is adapted for sealing in the elongated hole;

FIGS. 7, 8 respectively show two parallel arranged connecting pins which, while maintaining a constant center distance, allow different distances between the axes of the fixing portions for different distances between the holes in a splashboard of a motor vehicle.

### DETAILED DESCRIPTION OF THE DRAWINGS

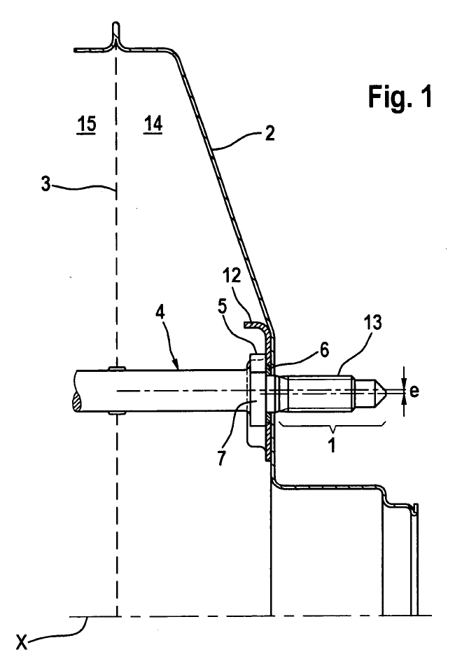

FIG. 1 shows a sketched partial longitudinal cross-sectional view of only those parts of a pneumatic brake booster which are essential for the invention, the booster being equipped in a per se known fashion with at least one longitudinally movable working piston 3 (which is not shown in detail in the drawings though) inside a two-part, shell-type housing 2. The working piston subdivides the housing 2 into at least two chambers 14, 15, and the working piston 3 sealed in the housing 2 transmits a force onto a push rod connectible to a master brake cylinder, depending on a force acting on a piston rod, as soon as the working piston is subjected to the effect of a pressure difference that prevails between the two chambers 14, 15.

One of two connecting pins 4 can be seen in FIG. 1, the pin portion thereof penetrating the housing 2 and the working piston being arranged in parallel to the illustrated longitudinal axis X of the housing 2. As is known, the end of the connecting pin 4 projecting from the housing 2 includes a fixing portion 1 in order to fix the brake booster to a splashboard of a motor vehicle.

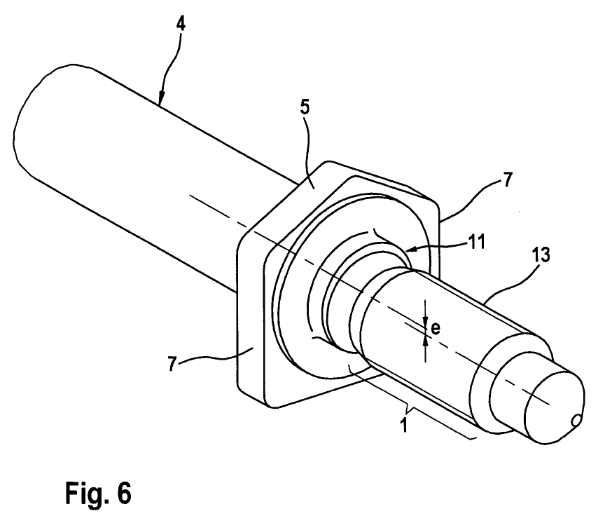

The invention arranges for all embodiments shown in FIGS. 1 to 7 that the fixing portion 1 is aligned eccentrically in relation to the portion of the connecting pin 4 that penetrates the housing 2 and the working piston 3.

As is apparent from the following drawings, the eccentricity of the fixing portion 1 at the connecting pin 4 renders it possible for the first time to realize different fitting dimensions at the splashboard with mainly equal components of the brake booster.

Further, it can be seen in FIG. 1 that a plate-shaped stop 5 is provided between the portion of the connecting pin 4 and the fixing portion 1 eccentrically aligned thereto, and a seal 6 is arranged at the end surface of said stop facing the inside surface of the housing 2. Between stop 5 and the inside surface of the housing 2, a reinforcing disc 12 is fixed, its opening being conformed to the hole in the housing 2. The fixing portion 1 includes a male thread 13 which extends through a bore in the splashboard of the motor vehicle for mounting the brake booster to the splashboard.

Although not depicted in FIG. 1, the additional connecting pin 4 is provided mirror-symmetrically relative to the longitudinal axis X in the housing 2 and equally includes an eccentric fixing portion 1 so that at least a pair of connecting pins 4 is distributed evenly over the housing periphery, the fixing portions 1 of said pins being furnished with male threads 13 that can be optimally adapted to the distance between the holes in the splashboard due to their eccentric misalignment. The fixing portions 1 that project through the holes in the splashboard have lock nuts in the vehicle's compartment.

Although the constant distance between the axes of the two connecting pins 4 in the housing amounts to 101.8 millimeters in the embodiment at topic, the eccentric arrangement of the two fixing pins 1 outside the housing 2 according to the invention allows realizing a center distance of 100 millimeters in a first eccentric position because in the present example each of the two fixing portions is offset at the connecting pins by the eccentric dimension e=0.9 millimeters in the direction of the longitudinal axis X. Hence, the brake booster fits into the two holes in the splashboard being spaced 100 millimeters from each other without there being the need to adapt the component dimensions within the housing 2.

Alternatively, a distance between the fixing portions of 101.8 millimeters is obtained in the event of a pin rotation opposed by 180 degrees, so that the same connecting pins 4 with the same distance dimensions within the housing 2 can be used for different distances of holes or bores in the splashboard in a favorable manner.

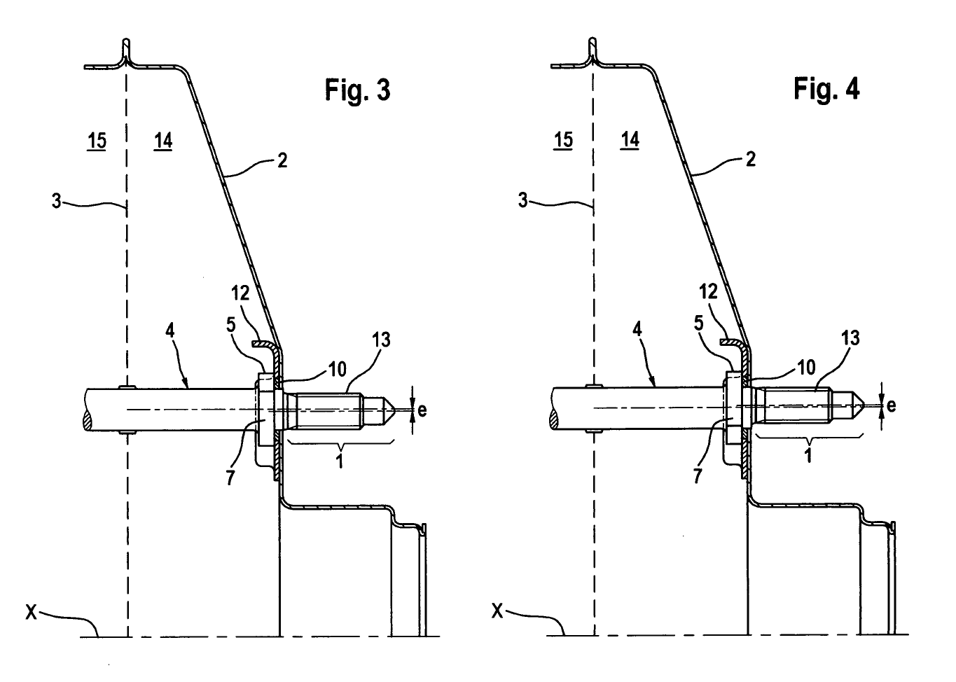

Thus, depending on the necessary distance between the axes of the two fixing portions 1 in this embodiment, only the shell half of the housing 2 that faces the splashboard must be exchanged, unless the favorable embodiment of the invention as disclosed in FIGS. 3 to 6 is resorted to.

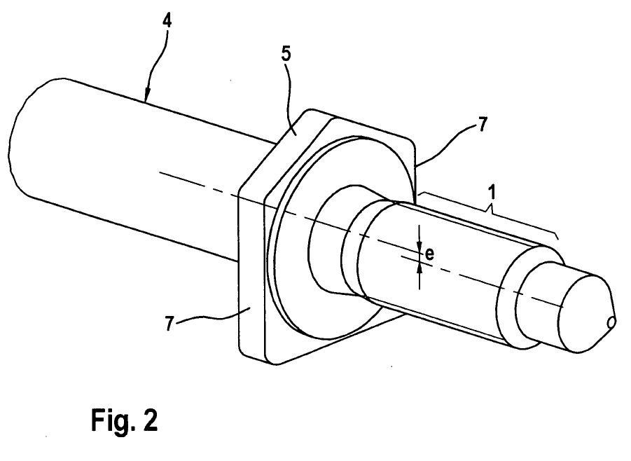

To begin with, however, additional expedient details of the embodiment shall be explained by way of FIG. 2 which represents an enlarged perspective view of the one connecting pin 4 shown in FIG. 1. The connecting pin 4 includes several guiding surfaces 7 which are positively engaged with mating guiding surfaces 8 arranged on the inside surface of the housing 2. These guiding surfaces 7 at the periphery of stop 5 are used for the position orientation of the fixing portion 1 in the housing 2 and preferably form an asymmetric multiple-cornered profile which defines the possible variations for the twisted position of the fixing portion 1 in the sense of a precise alignment and for the purpose of a rotation-prevention mechanism of the fixing portions 1.

Further, it can be seen in FIG. 2 that the pin-shaped fixing portion 1 on the end surface of the plate-shaped stop 5 is offset from the longitudinal axis of the connecting pin 4 by the eccentric dimension e so that the form-locking alignment of the connecting pin 4 in the housing 2 is suitably unaffected by the axle shift.

Different from the previous embodiments in FIGS. 1, 2, FIG. 3 shows another advantageous embodiment of the invention, according to which the fixing portion 1 of the connecting pin 4 extends through an opening of the housing 2 which is designed as an elongated hole 9 to achieve a possible variation of the twisted position of the fixing portion 1. This fact is favorable because it obvious the need to use different housings 2, as has been mentioned before, the rear housing shell of which must be adapted to the different distances between the axes of the two fixing portions 1 for the passage of the fixing portions 1. The process of selecting housings as mentioned with respect to FIGS. 1, 2 is thus omitted due to the arrangement of elongated holes 9 in the housing 2.

The eccentric dimension e.g. amounts to e=0.45 millimeters in FIGS. 3 and 4, and both connecting pins 4 with their fixing portions being arranged in parallel below and above the longitudinal axis X are rotated about the eccentric dimension e relative to the longitudinal axis X in FIG. 3 in a way similar to FIG. 1, while in FIG. 4 the two fixing portions 1 are tilted outwards in half a rotation by the eccentric dimension e in opposite direction. Thus, with a constant distance between the axes of the connecting pins 4 of 100.9 millimeters, either a distance between the axes of the fixing portions 1 of 100 millimeters (see FIG. 3) or 101.8 millimeters (see FIG. 4) is achieved so that, depending on the existing distance of bores in the splashboard, either the one or the other above-mentioned orientation in mounting of the two connecting pins 4 within the vertical elongated holes 9 prevails in the single housing 2 of standardized use. Consequently, it is no longer required to select a housing.

A reinforcing disc 12 for each connecting pin 4 is fixed between the stop 5 and the inside surface of the housing 2, the opening of the reinforcing disc being conformed to the elongated hole 9 in the housing 2 so that also with respect to the reinforcing disc 12 one single type of construction of disc can be used for different distances between the axes of the fixing elements 1.

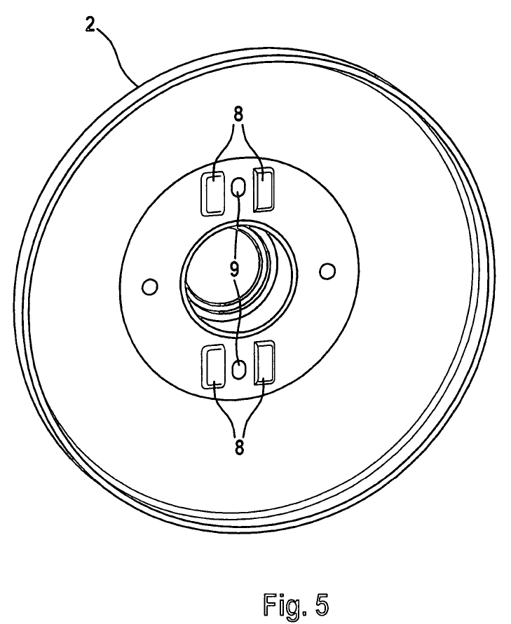

FIG. 5 shows in a spatial representation an inside view of a shell half of the housing 2 to illustrate the arrangement of the two vertical elongated holes 9 in the housing 2 which are arranged between several guiding surfaces 8 that are pressed in like noses at the inside surface of the housing 2. The large opening arranged centrically in the housing 2 is used to accommodate a per se known control housing into which the various valve components and the piston rod are inserted.

Making reference to FIGS. 3, 4, FIG. 6 shows a perspective view of one of the two connecting pins 4 having a contour adapted for being sealed in the elongated hole 9 of the housing 2, to what end the stop 5 has a sealing contour 11 adapted to the elongated hole 9 at the end surface facing the inside surface of the housing, on which contour the seal 10 illustrated in FIGS. 3, 4 will abut after being assembled with the reinforcing disc 12.

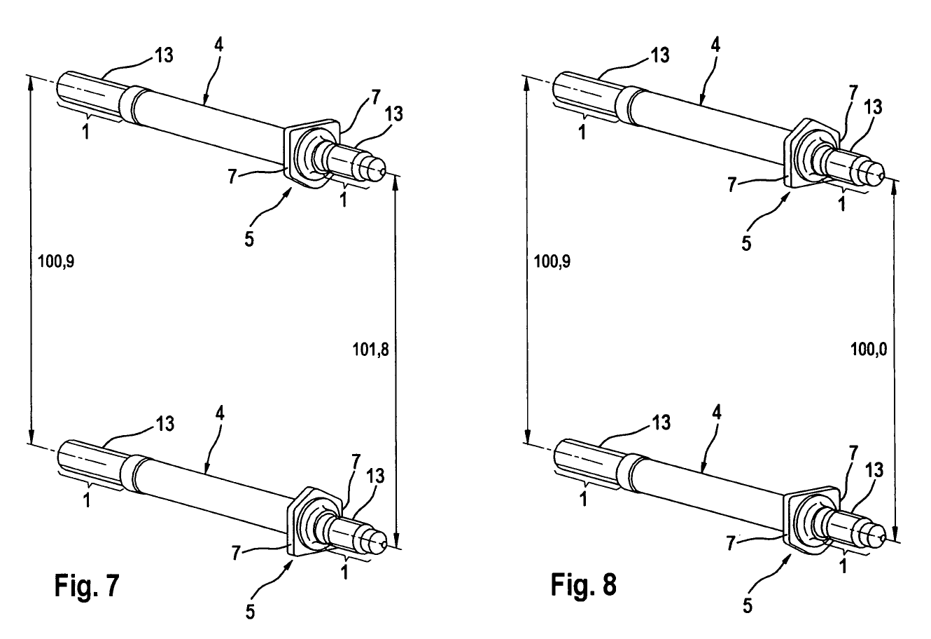

FIGS. 7, 8 illustrate the above-described different installation positions of the two connecting pins 4 in the housing 2, and the selected asymmetric multiple-cornered profile at the stops 5 not only provides a simple rotation-prevention mechanism but also allows easy detection of the installation position and, thus, the chosen distance between the axes of the two fixing elements 1 at the connecting pins 4. There is no more need for a complicated measurement of the distance between the axes of the two fixing elements 1.

In the illustration of FIG. 7, the tips of the multiple-cornered profiles at the two connecting pins 4, which tips are produced from several guiding surfaces 7, face each other what corresponds to a maximum eccentric excursion of the two fixing elements 1 by 2×0.45 millimeters in the embodiment at issue (cf. FIG. 4), so that the distance between the axes of the two fixing portions amounts to 101.8 millimeters (with a constant distance of the connecting pins of 100.9 millimeters).

In contrast thereto, the tips of the multiple-cornered profiles at the two connecting pins 4 are averted from one another in the illustration of FIG. 8, what corresponds to a center distance of 100 millimeters in the present example due to the inwards pointing fixing elements 1 (cf. FIG. 3).

It is, of course, also possible to implement the idea of the invention for a brake booster which does not have a connecting pin that penetrates the housing on both sides but only has a fixing portion on a stop at the rear housing shell so that different distances between the axes of the fixing portions can be adjusted to conform with the distance of bores in the splashboard due to an eccentric arrangement of the fixing portion at the stop, what is similar to the previous explanations.

### List of Reference Numerals

1 fixing portion
2 housing
3 working piston
4 connecting pin
5 stop
6 seal
7 guiding surface
8 guiding surface
9 elongated hole
10 seal
11 sealing contour
12 reinforcing disc
13 male thread
14 chamber
15 chamber
e eccentric dimension
X longitudinal axis

1-8. (canceled)

9. A brake booster for a motor vehicle comprising:
a housing having at least one longitudinally movable working piston that subdivides the housing into at least two chambers;
a push rod connectible to a master brake cylinder depending on a force acting upon a piston rod; and
a connecting pin having at least one portion that penetrates the housing and the working piston in parallel to the push rod and piston rod, wherein the working piston sealed in the housing transmits a force onto the push rod when the working piston is subjected to a difference in pressure prevailing between the two chambers and each end of the connecting pin projects from the housing including a fixing portion for connecting the brake booster to the master brake cylinder and a splashboard of the motor vehicle, and the fixing portion is aligned eccentrically relative to the portion of the connecting pin that penetrates the housing and the working piston.

10. The device according to claim 9, wherein a stop is provided between the portion of the connecting pin and the fixing portion that is aligned eccentrically thereto, and a seal is arranged at an end surface of the stop facing an inside surface of the housing.

11. The device according to claim 10, wherein at least one guiding surface is disposed at a periphery of the stop and is positively engaged with a guiding surface arranged at the inside surface of the housing.

12. The device according to claim 11, wherein a position orientation of the fixing portion on the housing, several guiding surfaces distributed at the periphery of the stop form an asymmetric multiple-cornered profile which predetermines possible variations for the twisted position of the fixing portion.

13. The device according to claim 12, wherein the fixing portion of the connecting pin extends through an opening in the housing which is designed as an elongated hole for the possible variation of the twisted position of the fixing portion.

14. The device according to claim 13, wherein the elongated hole is closed by a seal which is fitted at a stop having a sealing contour adapted to the elongated hole for the accommodation of the seal.

15. The device according to claim 14, wherein a reinforcing disc is fixed between the stop and the inside surface of the housing, the opening of the reinforcing disc being adapted to the elongated hole in the housing.

16. The device according to claim 9, wherein several connecting pins in the housing are evenly distributed over the housing periphery, and the fixing portions of the connecting pins are provided with a male thread respectively extending through a bore in a splashboard of a motor vehicle.
